(19) United States
(12) Patent Application Publication
(10) Pub. No.: US 2005/0116857 A1
(43) Pub. Date: Jun. 2, 2005

(54) Method and dual-frequency gps receiver

(75) Inventors: Nicolas Martin, Borg Les Valence (FR); Blandine Coatantiec, Bourg Les Valence (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES, Neuilly sur Seine (FR)

(21) Appl. No.: 10/499,198

(22) PCT Filed: Dec. 10, 2002
(86) PCT No.: PCT/FR02/04267

(51) Int. Cl. G01S 5/14

(52) U.S. Cl. 342/357.02

(57) ABSTRACT

The invention relates to satellite radionavigation, in particular satellites radionavigation of GPS (Global Positioning System), Galileo, GLONASS (Global Navigation Satellite System, Russian definition) type. The solutions advocated by the state of the art for correcting the ionospheric error through the use of a dual-frequency receiver make the measurement less robust to the dynamic if the band used is narrow and less accurate if the band used is wide. The invention proposes a process comprises step a change of reference of the dual-frequency base to a (mean, offset) base, a correction on at least the offsets loop so as to obtain the offsets speed in this (mean, offset) base, an inverse change of reference so to as calculate on the basis of the offsets speed in the (mean, offset) base the relative speed in the dual-frequency base, and a correction of the code speed for each of the two frequencies by the relative speed obtained in the dual-frequency base.

The invention relates to satellite radionavigation, in particular satellite radionavigation of GPS (Global Positioning System), Galileo, GLONASS (Global Navigation Satellite System, Russian definition) etc., type.

Satellite radionavigation makes it possible to obtain the position of the receiver by a method much like triangulation. The distances are measured on the basis of signals sent by satellites.

The signals transmitted by the satellites are formed by modulating the carrier of the signal with a spreading code. Thus, the satellite signals allow two types of measurement for locating the receiver. Moreover, the modulation of the carrier by a spreading code extends the spectrum in the spectral band, thereby boosting the resistance of the system to jamming. Also, furthermore, this makes it possible to distinguish between the satellites (by using a different code per satellite).

The first type of distance measurement by satellite radionavigation is a conventional measurement based on the carrier of the signal received. The measurements based on the phase of the carrier are accurate but ambiguous. Thus, the receiver is capable of evaluating the number of wavelengths between the satellite and the receiver to within modulo the wavelength.

The second type of distance measurement uses the code of the signal received. Unlike the measurements based on the carrier, the measurements based on the code are not ambiguous, since the receiver is capable of evaluating the integer number of code periods between the satellite and the receiver. However, the measurements based on the code are much less accurate than those based on the phase.

To perform these two types of measurement, the receiver acquires and tracks the signal received. To do this, it generates so-called local replicas of the code and of the carrier, which it correlates with the signal received. The code and the carrier being incoherent information, the generations of the code replica and carrier replica are controlled by two distinct loops.

The receiver uses these two loops to obtain accurate and unambiguous measurements. In a first phase, the so-called acquisition phase, the receiver functions in open loop so as to search for the signal received by testing several hypothesis regarding position and speed of the local code and of the local carrier. Once the code search has made it possible to resolve the ambiguity, the receiver functions in closed loop. The code loop is aided by the carrier loop speed-wise making it possible to exploit the accuracy offered by the phase measurement with no limitation by the ambiguity. Thus, the dynamic of the carrier and of the clock are eliminated and the code measurement can be further filtered (smoothing of the code by the carrier) so as to improve the accuracy thereof.

When the code passband used is narrow, there is a risk of tailoff or even of the loss of lock of the code loop on account of the residual dynamic. When the band used is wide so as to come within the dynamic, the measurements are noisy.

The measurements thus obtained are marred with so-called ionospheric errors, due to the propagation through the ionosphere, the effects of which depend on frequency. This phenomenon induces measurement errors of like value but of opposite sign between the code and the carrier. There is therefore incoherence between the carrier loop and the code loop. The dynamic of these errors, small but not negligible, necessitates a minimum passband of the code loop and hence potentially limits the accuracy.

Single-frequency receivers do not make it possible to evaluate the ionospheric error. This error can therefore only be corrected roughly through a bias.

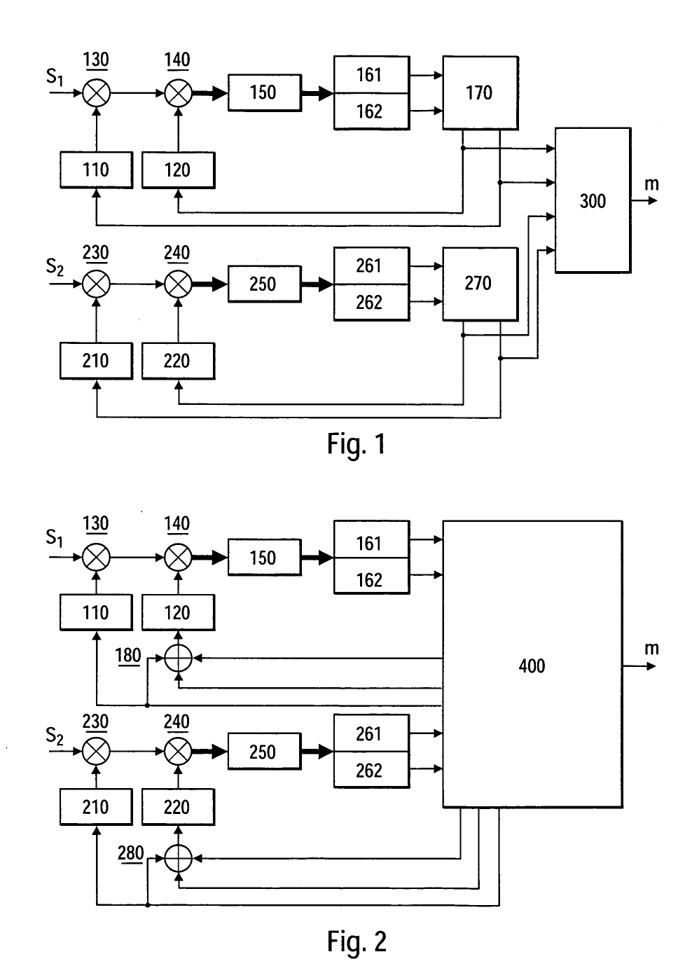

The ionospheric error depending on frequency, the use of a dual-frequency receiver makes it possible to calculate the offset between these two frequencies, to deduce the absolute ionospheric error therefrom and to correct the speed aid sent to the code loop as shown by FIG. 1.

The two signals s₁ and s₂ correspond to two distinct frequencies. Traditionally, these two signals s₁ and s₂ are processed independently. The signals s₁ (respectively s₂) are correlated by the carrier 130 (respectively 230) then by the code 140 (respectively 240). The signals thus obtained from the signals s₁ (respectively s₂) are processed by the integration and resetting device 150 (respectively 250).

At the output of the integration and resetting device 150 are obtained four signals: the signal I_{A}¹ formed by the aggregate samples in-phase for the carrier and phase lead for the code, the signal I_{R}¹ formed by the aggregate samples in-phase for the carrier and phase lag for the code, the signal Q_{A}¹ formed by the aggregate samples in quadrature of the carrier and phase lead for the code, the signal Q_{R}¹ formed by the aggregate samples in quadrature for the carrier and phase lag for the code. Also, at the output of the integration and resetting device 250 are obtained four signals: the signal I_{A}² formed by the aggregate samples in-phase for the carrier and phase lead for the code, the signal I_{R}² formed by the aggregate samples in-phase for the carrier and phase lag for the code, the signal Q_{A}² formed by the aggregate samples in quadrature for the carrier and phase lead for the code, the signal Q_{R}² formed by the aggregate samples in quadrature for the carrier and phase lag for the code.

The signals I_{A}¹, I_{R}¹, Q_{A}¹, Q_{R}¹ (respectively I_{A}², I_{R}², Q_{A}² Q_{R}²) are processed by a phase discriminator 161 (respectively 261) and code discriminator 162 (respectively 262). The information obtained by the discriminators 161 and 162 (respectively 261 and 262) are used by the loop corrector 170 (respectively 270) to deliver the carrier speed to the carrier oscillator 110 (respectively 210) and the code speed to the code oscillator 120 (respectively 220). These oscillators 110, 120, 210 and 220 are for example numerically controlled oscillators (NCO). The carrier oscillator 110 (respectively 210) makes it possible to generate a carrier replica used for the correlation 130 (respectively 230) with the signal s₁ (respectively s₂). The code oscillator 120 (respectively 220) makes it possible to generate a code replica used for the correlation 140 (respectively 240) with the signal s₁ (respectively s₂) correlated by the carrier replica. The device 300 calculates by linear combination the measurement corrected on the basis of the two measurements marred with the ionospheric error originating from the two independently processed signals.

Such a solution makes the measurement less robust to the dynamic if the band used is narrow and less accurate if the band used is wide.

The present invention makes it possible to alleviate these drawbacks, in particular the use of a narrow band allowing good accuracy while having a system robust to dynamic. The invention proposes a process of dual-frequency reception, the relative dynamic of the signals received being small, said process comprising per frequency a code loop and a carrier loop that are incoherent and at least the following steps:
a change of reference of the dual-frequency base to a (mean, offset) base,
a correction on at least the offsets loop so as to obtain the offsets speed in this (mean, offset) base,
an inverse change of reference so to as calculate on the basis of the offsets speed in the (mean, offset) base the relative speed in the dual-frequency base,
a correction of the code speed for each of the two frequencies by the relative speed obtained in the dual-frequency base.

The invention consists of a (mean, offset) converter of a dual-frequency receiver with carrier loop and incoherent code loop, allowing the change of reference of the phases of each of the frequencies to their phase mean and their phase offset if it receives information dependent on these said phases.

An exemplary (mean, offset) converter according to the invention receives, for each of the two frequencies, at least one signal e₁ (respectively e₂) originating from at least one discriminator 161, 162, 261 or 262 associated with this frequency, each of these signals being weighted by a weighting coefficient λ₁ (respectively λ₂) associated with the signal, and calculates the offset Δ=λ₁ e₁−λ₂ e₂ and the mean Σ=αλ₁ e₁−βλ₂ e₂ of these weighted signals, α and β being coefficients whose value is determined as a function of the respective incoming signals e₁ and e₂.

Another subject of the invention is an inverse (mean, offset) converter 415 of a dual-frequency receiver with carrier loop and incoherent code loop, characterized in that it allows at least the obtaining of the relative speed if it receives the phase offset speed of the two frequencies.

An exemplary inverse (mean, offset) converter according to the invention consists of an inverse (mean, offset) converter 415 receiving the speed of the offset vₑ and the speed of the mean vₘ respectively from the corrector of the offsets loop 413 and from the corrector of the mean loop 414, and calculating for each of the two frequencies the carrier speeds and/or the relative speed (respectively the code speeds) if the signals converted by the (mean, offset) converter 412 originate from a phase discriminator 161, 261 (respectively from a code discriminator 162, 262).

In one of its variants, the invention proposes a loop corrector of a dual-frequency receiver with carrier loop and incoherent code loop, comprising:
at least four inputs, the first two receiving the signals from the phase discriminators 161, 261 of the two frequencies and the following two receiving the signals from the code discriminators 162, 262 of the two frequencies,
at least one weighter 411, 416 coupled to each input, the weighting value λ being the wavelength of the signal for the first two inputs and the shift length for the following two,
a (mean, offset) converter 412 according to the invention receiving the first two weighted inputs and delivering the phase offset and mean and/or (mean, offset) converter 412 according to the invention receiving the following two weighted inputs and delivering the code offset and the mean,
coupled to the offset output of each (mean, offset) converter 412 an offsets loop 413 and to the mean output of each (mean, offset) converter 412 a mean loop 414,
an inverse (mean, offset) converter 415 according to the invention coupled to each of the offsets loop 413/mean loop 414 pairs.

The invention consists, furthermore, of a dual-frequency receiver comprising per frequency a code loop and a carrier loop that are incoherent, said dual-frequency receiver receiving signals whose relative dynamic is small, comprising at least:
a (mean, offset) converter 412 according to the invention allowing the change of reference of the phases to their phase mean and their phase offset,
a phase offsets loop corrector 413 making it possible to obtain on the basis of the phase offsets emanating from the converter a phase offset speed,
an inverse (mean, offset) converter 415 according to the invention allowing the change of reference of the phase offset speed so as to obtain the relative speed,
two correctors 180 and 280 of the code speed, one per frequency, each receiving the respective code speed, carrier speed and relative speed emanating from the inverse converter, and each delivering its respective corrected code speed to its respective code loop.

In a first variant of the dual-frequency receiver according to the invention, the (mean, offset) converter 412 receives the carrier measurements calculated on the basis of the two frequencies.

In a second variant of the invention, a dual-frequency receiver comprising per frequency a code loop and a carrier loop that are incoherent, said dual-frequency receiver receiving signals whose relative dynamic is small, comprises at least:
a loop corrector for example as described previously delivering the relative speed and for each of the two frequencies the code speed and the carrier speed,
two code speed correctors 180 and 280, one per frequency:
   each receiving said code speed, carrier speed and relative speed weighted by −2/λ², where λ is the wavelength associated with the frequency of the code speed corrector, and
   each delivering its respective corrected code speed to respective code oscillator.

The characteristics and advantages of the invention will become more clearly apparent on reading the description, given by way of example, and of the figures pertaining thereto which represent:

FIG. 1, a dual-frequency receiver for the measurement of distance with correction of the ionospheric error according to the state of the art,

FIG. 2, a diagrammatic representation of an exemplary dual-frequency receiver for the measurement of distance with correction of the ionospheric error according to the invention,

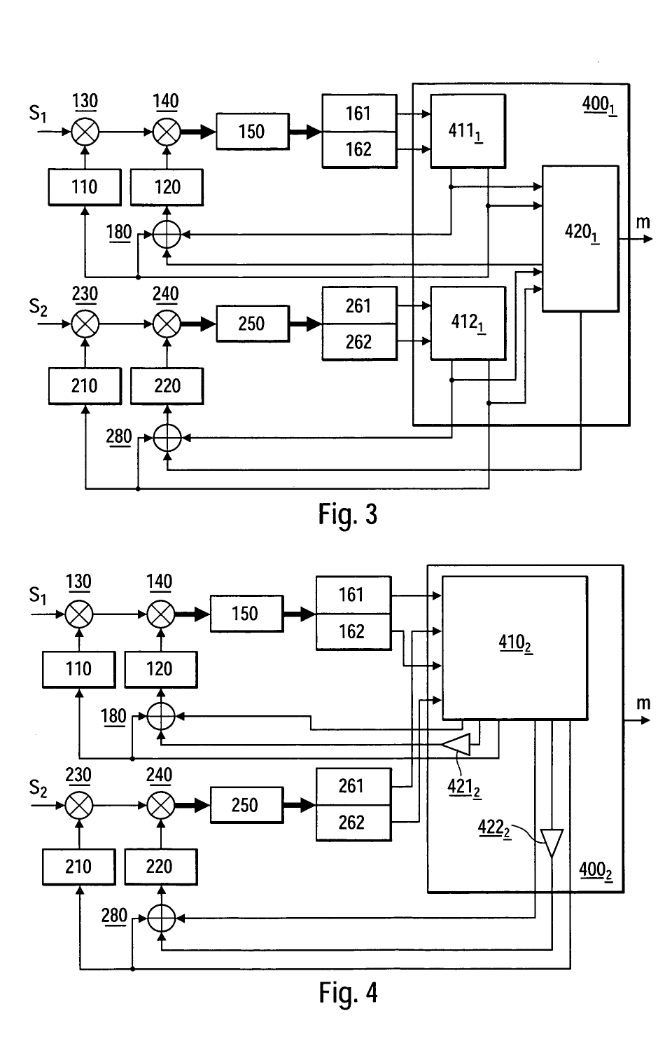

FIG. 3, a first variant of the dual-frequency receiver for the measurement of distance with correction of the ionospheric error according to the invention,

FIG. 4, a second variant of the dual-frequency receiver for the measurement of distance with correction of the ionospheric error according to the invention,

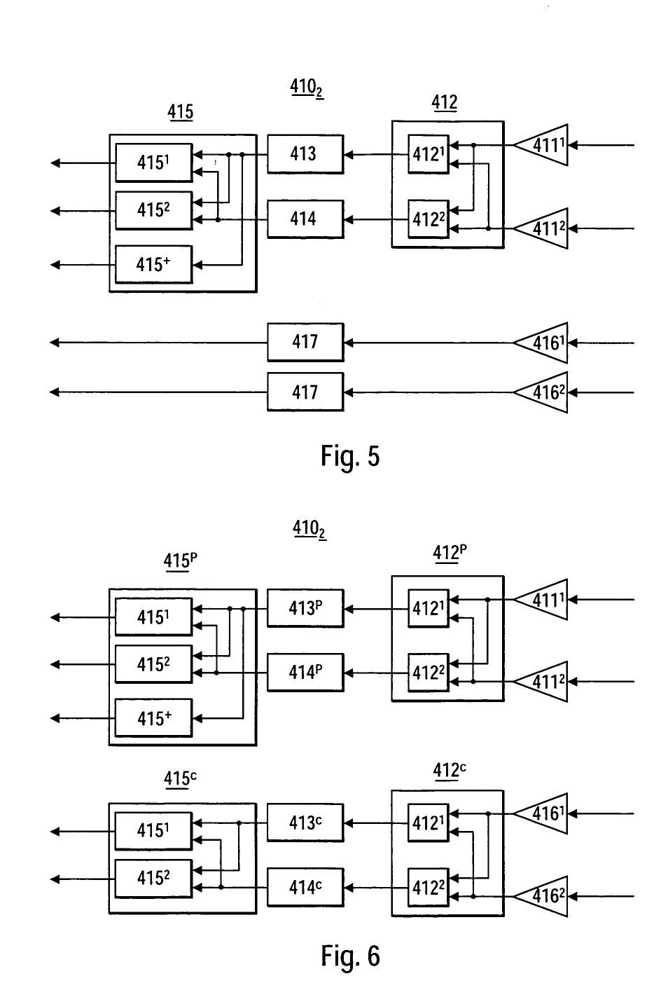

FIG. 5, a first exemplary loop corrector of the second variant of the dual-frequency receiver according to the invention,

FIG. 6, a second exemplary loop corrector of the second variant of the dual-frequency receiver according to the invention.

FIG. 2 shows a generic diagrammatic representation of an exemplary dual-frequency receiver for the measurement of distance with correction of the ionospheric error according to the invention. The phase discriminators 161 and 261 of the two frequencies and the code discriminators 162 and 262 are coupled to the system 400 which calculates the carrier speed and code speed for each frequency as well as the ionospheric speed.

The ionospheric speed will correct the code speeds of each of the two frequencies so as to remove the errors induced by the propagation of the signals through the ionosphere. This correction is performed for each frequency with the aid of a code speed corrector 180 and 280. This ionospheric speed is calculated by the system 400 not in the dual-frequency base but in the (mean, offset) base and is then translated into the dual-frequency base.

The distance measurements m emanating from the system 400 are thus more accurate owing to the separation of the dynamic. Specifically, the use of the (mean, offset) base allows the use of a narrow band for the offset, whose dynamic is small, so as to improve the accuracy, and to aggregate the energies for the mean so as to improve the accuracy and the robustness to jamming.

In its first variant represented by FIG. 3, for each frequency the receiver has at its disposal a loop corrector 411₁ and 412₁ within the system 400₁. Thus, for each frequency, the discriminators 161, 162, 261 or 262 associated 161 and 162 (respectively 261 and 262) are coupled to the associated loop corrector 411₁ (respectively 412₁). A device 420₁ receives the code speed and carrier speed for each frequency since it is coupled to the outputs of the two loop correctors 411₁ and 412₁. This device 420₁ delivers the ionospheric speed to the code speed correctors 180 and 280.

The ionospheric speed and the carrier speeds originating from the loop corrector 411₁ and 412₁ associated with each of the two frequencies will correct the code speeds originating from the loop corrector 411₁ and 412₁ associated with each of the two frequencies. This code speed correction by the ionospheric speed and the associated carrier speed makes it possible to remove the errors induced by the propagation of the signals through the ionosphere. It is performed with the aid for each frequency with the aid of a code speed corrector 180 and 280. This ionospheric speed is calculated by the device 420₁ not in the dual-frequency base but in the (mean, offset) base and then translated into the dual-frequency base.

For each frequency, the code speed is, furthermore, corrected by the carrier speed calculated by the respective loop corrector 411₁ and 412₁ with the aid of a code speed corrector 180 and 280.

The distance measurements m emanating from the device 420₁ are therefore more accurate on account of the separation of the dynamic.

In its second variant represented by FIG. 4, the receiver has at its disposal a loop corrector 410₂ common to the two frequencies within the system 400₂.

Thus, the phase discriminators 161 and 261, and the code discriminators 162 and 262 of the two frequencies are coupled to the common loop corrector 410₂. The phase discriminators 161 and 261 are coupled to the first two inputs of the loop corrector 410₂ and the code discriminators 162 and 262 are coupled to the following two inputs of the loop corrector 410₂.

The loop corrector 410₂ calculates, on the basis of the signals thus received, the code speed and carrier speed for each frequency as well as the ionospheric speed. The ionospheric speed is weighted for each frequency by a gain 421₂ (respectively 422₂) within the system 400₂, then delivered to the code speed corrector 180 (respectively 280). The gains 421₂ and 422₂ are equal to −2.λ², where λ is the wavelength associated with each frequency.

The ionospheric speed at the output of the system 400₂ will correct the code speeds originating from the common loop corrector 410₂ for each of the two frequencies. This code speed correction by the ionospheric speed makes it possible to remove the errors induced by the propagation of signals through the ionosphere. It is performed with the aid for each frequency with the aid of a code speed corrector 180 and 280. This ionospheric speed is calculated by the loop corrector 410₂ not in the dual-frequency base but in the (mean, offset) base and then translated into the dual-frequency base. For each frequency, the code speed is, furthermore, corrected by the carrier speed calculated by the loop corrector 410₂ with the aid of a code speed corrector 180 and 280.

The distance measurements m emanating from the system 400₂ are thus more accurate on account of the separation of the dynamic.

In the first exemplary loop corrector 410₂ common to the two frequencies, proposed by FIG. 5, only the signals received on its first two inputs and originating from the phase discriminators 161 and 261 are transposed from the dual-frequency base to the (mean, offset) base. The four signals e₁^{p}, e₂^{p}, e₁^{c}, and e₂^{c} received by the loop corrector 410₂ are weighted by associated weighting coefficients 411₁, 411₂, 416₁ and 416₂.

These weighting coefficients 411¹, 411², 416¹ and 416² are, either the wavelength of the signal originating from the phase discriminator, or the shift length (otherwise known as “chip” length) of the signal originating from the code discriminator. Hence, the weighting coefficient 411¹ of the signal e₁^{p} originating from the phase discriminator 161 associated with the first frequency has as value the wavelength λ₁^{p} of this signal. The weighting coefficient 411² of the signal e₂^{p} originating from the phase discriminator 261 associated with the second frequency has as value the wavelength λ₂^{p} of this signal. Hence, the weighting coefficient 416¹ of the signal e₁^{c} originating from the phase discriminator 162 associated with the first frequency has as value the wavelength λ₁^{c} of this signal. The weighting coefficient 416² of the signal e₂^{c} originating from the phase discriminator 262 associated with the second frequency has as value the wavelength λ₂^{c} of this signal.

The signals e₁^{p} and e₂^{p} originating from the phase discriminators 161 and 261 are transposed to the (mean, offset) base with the aid of a (mean, offset) converter 412 receiving these weighted signals, that is to say λ₁^{p} e₁^{p} and λ₂^{p} e₂^{p}. The devices 412¹ and 412² of the converter calculate, on the basis of the two incoming signals respectively the offset and the mean. The device 412¹ is therefore an offset calculator and the device 412² a mean calculator.

Generally, regardless of the type of discriminator 161, 162, 261 or 262 from which the signals λ₁ e₁ and λ₂ e₂ received by the (mean, offset) converter 412 originate, the output of the offset calculator 412¹ is equal to Δ=λ₁ e₁−λ₂ e₂ and the output of the mean calculator 412² is equal to Σ=α λ₁ e₁+β λ₂ e₂, α and β being coefficients whose value is determined as a function of the respective incoming signals e₁ and e₂.

In the example of FIG. 5, the incoming signals λ₁^{p} e₁^{p} and λ₂^{p} e₂^{p}, originating from phase discriminators 161, 261, the values at the output of the (mean, offset) converter 412 are the phase offset and the phase mean of two frequencies. Also, the coefficients α and β are calculated as a function of the signal-to-noise ratios estimated on the two frequencies and of the wavelength.

The output of the offset calculator 412¹ is coupled to an offset loop corrector 413 delivering the offset speed vₑ and the output of the mean calculator 421² is coupled to a mean loop corrector 414 delivering the mean speed vₘ. These two speeds, offsets speed vₑ and means speed vₘ, are transmitted to an (mean, offset) inverse converter 415. The (mean, offset) inverse converter 415 transposes the speeds that it receives into the dual-frequency base.

In the case of FIG. 5, the speeds received by the (mean, offset) inverse converter 415 being the phase offsets speed vₑ^{p} and phase means speed vₘ^{p}, the speeds at the output of the converter are the carrier speeds for the two frequencies and the ionospheric speed. The device 415¹, dubbed subconverter f1, calculates the carrier speed associated with the first frequency on the basis of the phase offsets speeds vₑ^{p} and the phase means speeds vₘ^{p}. The device 415², dubbed subconverter f2, calculates the carrier speed associated with the second frequency on the basis of the phase offsets speeds vₑ^{p} and phase means speeds vₘ^{p}. Also, the device 415⁺, dubbed iono subconverter, calculates the ionospheric speed on the basis of the phase offsets speed vₑ^{p}.

In general, regardless of the type of offsets speed vₑ and means speed vₘ at the input of the (mean, offset) inverse converter 415, the output from subconverter f1 associated with α is equal to

$$\frac{1}{α + β} {v}_{m} + \frac{β}{α + β} {v}_{e} ,$$

and the output from subconverter f2 associated with β is equal to

$$\frac{1}{α + β} {v}_{m} + \frac{α}{α + β} {v}_{e} .$$

In the particular case depicted by FIG. 5, the (mean, offset) inverse converter 415 has at its disposal an extra output on which it delivers the ionospheric speed calculated by the iono subconverter 415⁺ and equal to

$$\frac{1}{{λ}_{1}^{2} - {λ}_{2}^{2}} .$$

The inputs e₁^{c}, and e₂^{c} of the loop corrector 410₂ of the example of FIG. 5 not being transposed into the (mean, offset) base, the output of each weighter 416¹ and 416² is coupled to a code loop corrector 417 calculating the code speed specific to each frequency.

In this example, the order and the loop band for the mean loop (414) are compatible with the dynamic of the carrier (high) and of the clock. The order and the loop band for the offsets loop are compatible with the dynamic of the ionospheric error (small). By eliminating the dynamic of the ionospheric error by virtue of the code speed correctors 180 and 280 (in addition to the dynamic of the carrier by virtue of the corrections by the carrier speeds) it is possible to considerably reduce the band of the code loops and hence to gain accuracy.

In the second exemplary loop corrector 410₂ common to the two frequencies, proposed by FIG. 6, the signals received on the four inputs, originating from the phase discriminators 161 and 261 for the first two inputs and from the code discriminators 162 and 262 for the following two inputs, are transposed from the dual-frequency base into the (mean, offset) base. The four signals e₁^{p}, e₂^{p}, e₁^{c}, and e₂^{c} received by the loop corrector 410₂ are weighted by associated weighting coefficients 411₁, 411₂, 416₁ and 416₂.

These weighting coefficients 411¹, 411², 416¹ and 416² are, either the wavelength of the signal originating from the phase discriminator, or the shift length (otherwise known as “chip” length) of the signal originating from the code discriminator. Hence, the weighting coefficient 411¹ of the signal e₁^{p} originating from the phase discriminator 161 associated with the first frequency has as value the wavelength λ₁^{p} of this signal. The weighting coefficient 411² of the signal e₂^{p} originating from the phase discriminator 261 associated with the second frequency has as value the wavelength λ₂^{p} of this signal. Hence, the weighting coefficient 416¹ of the signal e₁^{c} originating from the phase discriminator 162 associated with the first frequency has as value the shift length λ₁^{c} of this signal. The weighting coefficient 416² of the signal e₂^{c} originating from the phase discriminator 262 associated with the second frequency has as value the shift length λ₂^{c} of this signal.

The four signals e₁^{p}, e₂^{p}, e₁^{c}, and e₂^{c} originating respectively from the phase discriminators 161 and 261, and from the code discriminators 162 and 262 are transposed into the (mean, offset) base with the aid of two (mean, offset) converters 412^{p} et 412^{c} receiving these weighted signals, that is to say λ₁^{p} e₁^{p}, λ₁^{p} e₂^{p}, λ₂^{c} e₁^{c} and λ₂^{c} e₂^{c}. The first (mean, offset) converter 412^{p} receives the signals e₁^{p}, e₂^{p} originating respectively from the phase discriminators 161 and 261, and the second (mean, offset) converter 412^{c} the signals e₁^{c}, and e₂^{c} originating respectively from the code discriminators 162 and 262.

In general, the devices 412¹ and 412² of the converter calculate, on the basis of the two incoming signals respectively the offset and the mean. The device 412¹ is therefore an offset calculator and the device 412² a mean calculator. Regardless of the type of discriminator 161, 162, 261 or 262 from which the signals λ₁ e₁ and λ₂ e₂ received by the (mean, offset) converter 412 originate, the output of the offset calculator 412¹ is equal to Δ=λ₁ e₁−λ₂ e₂ and the output of the mean calculator 412² is equal to Σ=α λ₁ e₁+β λ₂ e₂, α and β being coefficients whose value is determined as a function of the respective incoming signals e₁ and e₂.

In the example of FIG. 6, for the incoming signals λ₁^{p} e₁^{p} and λ₂^{p} e₂^{p}, originating from phase discriminators 161 and 261, the values at the output of the (mean, offset) converter 412^{p} are the phase offset and the phase mean of the two frequencies. Also, the coefficients α^{p} and β^{p} are calculated as a function of the signal-to-noise ratios estimated on the two frequencies and of the wavelength. Whereas for the incoming signals λ₁^{c} e₁^{c} and λ₂^{c} e₂^{c}, originating from code discriminators 162 and 262, the values at the output of the (mean, offset) converter 412^{c} are the code offset and the code mean of two frequencies. Also, the coefficients α^{c} and β^{c} are calculated as function of the signal-to-noise ratios estimated on the two frequencies and of the shift length (otherwise known as “chip” lengths).

In general, the output of the offset calculator 412¹ is coupled to an offset loop corrector 413 delivering the offset speed vₑ and the output of the mean calculator 412² is coupled to a mean loop corrector 414 delivering mean speed vₘ. These two speeds, offsets speed vₑ and means speed vₘ, are transmitted to an (mean, offset) inverse converter 415. The (mean, offset) inverse converter 415 transposes the speeds that it receives into the dual-frequency base.

In the case of FIG. 6, the speeds received by the (mean, offset) inverse converter 415^{p} being the phase offsets speed vₑ^{p} of the phase offsets loop 413^{p} and the phase means speed vₘ^{p} of the phase mean loop 414^{p}, the speeds at the output of the (mean, offset) inverse converter 415^{p} are the carrier speeds for the two frequencies and the ionospheric speed; and the speeds received by the (mean, offset) inverse converter 415^{c} being the code offsets speed vₑ^{c} of the phase offsets loop 413^{c} and code means speed vₘ^{c} of the phase mean loop 414^{c}, the speeds at the output of the (mean, offset) inverse converter 415^{c} are the code speeds for the two frequencies.

In general, within an (mean, offset) inverse converter 415, the device 415¹, dubbed subconverter f1, calculates the carrier speed associated with the first frequency on the basis of the offsets speeds vₑ and the means speeds vₘ. The device 415², dubbed subconverter f2, calculates the speed associated with the second frequency on the basis of the offsets speeds vₑ and means speeds vₘ. Regardless of the type of offsets speed vₑ and means speed vₘ at the input of the (mean, offset) inverse converter 415, the output from subconverter f1 associated with a is equal to

$$\frac{1}{α + β} {v}_{m} + \frac{β}{α + β} {v}_{e} ,$$

and the output from subconverter f2 associated with β is equal to

$$\frac{1}{α + β} {v}_{m} + \frac{α}{α + β} {v}_{e} .$$

In particular, if the speeds received by the (mean, offset) inverse converter 415^{p} are phase offsets speeds vₑ^{p} and phase means speeds vₘ^{p}, the speeds at the output are carrier speeds; if the speeds received by the (mean, offset) inverse converter 415^{c} are code offset speeds vₑ^{c} and code means speeds vₘ^{c}, the speeds at the output are code speeds.

Moreover, the device 415⁺, dubbed iono subconverter, of the (mean, offset) inverse converter 415^{p}, receiving phase offsets speeds vₑ^{p} and phase means speeds vₘ^{p}, calculates the ionospheric speed on the basis of the phase offsets speed vₑ^{p}. In the particular case depicted by FIG. 6, the (mean, offset) inverse converter 415 has at its disposal an extra output on which it delivers the ionospheric speed calculated by the iono subconverter 415⁺ and equal to

$$\frac{1}{{λ}_{1}^{2} - {λ}_{2}^{2}} .$$

Another example (not illustrated) would consist in transposing only the outputs of the code discriminators 162, 262 into the (mean, offset) base.

The ionospheric speed calculated to correct the errors related to the propagation of the signals through the ionosphere. Now, the signals of different frequencies propagating through the ionosphere have a relatively small dynamic. Hence, more generally the various systems and devices described may be applied in any dual-frequency receiver having incoherent code and carrier loop whose different frequency signals have a relatively small dynamic. The speed calculated to correct the errors inducing this small relative dynamic is dubbed the relative speed.

This type of dual-frequency reception system for the measurement of distance with incoherent carrier and code loop using the invention can be applied not only to GPS, to Glonass and to Galileo but also to any application requiring the use of a dual-frequency receiver with incoherent carrier and code loop and receiving signals with small relative dynamic.

1. A dual-frequency reception method including per frequency a code loop and a carrier loop that are incoherent, the relative dynamic of the signals received being small, the method comprising the steps of:
changing a reference of the dual-frequency base to a (mean, offset) base;
correcting on an offsets loop so as to obtain the offsets speed in the (mean, offset) base;
calculating using an inverse change of reference on the basis of the offsets speed in the (mean, offset) base the relative speed in the dual-frequency base; and
correcting the code speed for each of the two frequencies by the relative speed obtained in the dual-frequency base.

2. A (mean, offset) converter of a dual-frequency receiver with carrier loop and code loop that are incoherent, comprising: a receiver which allows the change of reference of the phases of each of the frequencies to their phase mean and their phase offset if the receiver receives information dependent on said phases.

3. The (mean, offset) converter as claimed in claim 2, wherein:
the receiver receives for each of the two frequencies at least one signal originating from at least one discriminator associated with one of the frequencies, each of the at least one signal being weighted by a weighting coefficient associated with the signal and
the receiver calculates the offset Δ=λ₁ e₁−λ₂ e₂ and the mean Σ=α λ₁ e₁+β λ₂ e₂ of the at least one weighted signal, α and β coefficient value are determined as a function of respective incoming signals e₁ and e₂.

4. The (mean, offset) converter as claimed in claim 3, wherein said discriminators delivering the incoming signals are phase discriminators or code discriminators.

5. The (mean, offset) converter as claimed in claim 4, wherein:
if said discriminators are phase discriminators, the weighting coefficients λ₁ and λ₂ are wavelengths and the coefficients α and β are calculated as a function of the signal-to-noise ratios estimated on the two frequencies and of the wavelength; and
if said discriminators are code discriminators, the weighting coefficients λ₁ and λ₂ are shift lengths and the coefficients α and β are calculated as a function of the signal-to-noise ratios estimated on the two frequencies and of the length of the shifts.

6. An inverse (mean, offset) converter of a dual-frequency receiver with carrier loop and incoherent code loop, wherein the dual frequency receiver allows at least the obtaining of the relative speed if the receiver receives the phase offset speed of the two frequencies.

7. The inverse (mean, offset) converter as claimed in claim 6, wherein:
the receiver receives the speed of the offset vₑ and the speed of the mean vₘ respectively from a corrector of the offsets loop and from a corrector of the mean loop, and
the receiver calculates for each of the two frequencies the carrier speeds and/or the relative speed (respectively the code speeds) if the signals converted by the (mean, offset) converter as claimed in claim 2 originate from a phase discriminator respectively from a code discriminator.

8. An inverse (mean, offset) converter wherein:
the relative speed is equal to the output from an offsets loop corrector weighted by
$$\frac{1}{{λ}_{1}^{2} - {λ}_{2}^{2}} .$$
; and
the carrier speed (respectively code speed) is equal to
$$\frac{1}{α + β} {v}_{m} + \frac{β}{α + β} {v}_{e}$$
for the frequency associated with α and
$$\frac{1}{α + β} {v}_{m} + \frac{α}{α + β} {v}_{e}$$
for the frequency associated with β if the discriminator is a phase discriminator.

9. A loop corrector of a dual-frequency receiver with carrier loop and incoherent code loop, comprising:
at least four inputs, the first two inputs receiving signals from the phase discriminators of the two frequencies and the following two inputs receiving signals from the code discriminators of the two frequencies;
at least one weighter coupled to each input, the weighting value λ being the wavelength of the signal received at the first two inputs and the shift length received at the following two;
a (mean, offset) converter as claimed in claim 2 receiving the first two weighted inputs and delivering the phase offset and mean and/or (mean, offset) converter as claimed in claim 2 receiving the following two weighted inputs and delivering the code offset and the mean;
coupled to the offset output of each (mean, offset) converter (an offsets loop and to the mean output of each (mean, offset) converter a mean loop; and
an inverse (mean, offset) converter as claimed in claim 6 coupled to each of the offsets loop/mean loop pairs.

10. A loop corrector as claimed in claim 9, comprising:
two code loop filters each coupled to one of the two following weighted inputs if the two following inputs receiving the signals originating from code discriminators are not coupled to a (mean, offset) converter after weighting; and
two carrier loop filters each coupled to one of the first two weighted inputs if these first two inputs receiving the signals originating from phase discriminators are not coupled to a (mean, offset) converter after weighting.

11. A dual-frequency receiver including per frequency a code loop and a carrier loop that are incoherent, said dual-frequency receiver receiving signals whose relative dynamic is small, comprising at least:
a (mean, offset) converter as claimed in claim 2 allowing a change of reference of the phases to their phase mean and their phase offset;
a phase offsets loop corrector for obtaining a phase offset speed, based on the phase offsets emanating from the (mean, offset) converter;
an inverse (mean, offset) converter as claimed in claim 6 allowing the change of reference of the phase offset speed so as to obtain the relative speed; and
two correctors of the code speed, one per frequency, each receiving the respective code speed, carrier speed and relative speed emanating from the inverse converter, and each delivering its respective corrected code speed to a respective code loop.

12. The dual-frequency receiver as claimed in claim 11, wherein the (mean, offset) converter receives the carrier measurements calculated on the basis of the two frequencies.

13. A dual-frequency receiver comprising per frequency a code loop and a carrier loop that are incoherent, said dual-frequency receiver receiving signals whose relative dynamic is small, comprising at least:
a loop corrector as claimed in claim 9 delivering the relative speed and for each of the two frequencies the code speed and the carrier speed;
two code speed correctors, one per frequency:
each code speed corrector receiving said code speed, carrier speed and relative speed weighted by −2/λ², where λ is the wavelength associated with the frequency of the code speed corrector, and
each code speed corrector delivering respective corrected code speed to a respective code oscillator.

14. The converter as claimed in claim 2, comprising:
two code loop filters each coupled to one of two following weighted inputs if the two following inputs receiving the signals originating from code discriminators are not coupled to a (mean, offset) converter after weighting,
two carrier loop filters each coupled to one of first two weighted inputs if the first two inputs receiving the signals originating from phase discriminators are not coupled to a (mean, offset) converter after weighting.

15. The loop corrector as claimed in claim 11, comprising:
two code loop filters each coupled to one of the following weighted inputs if the two following inputs receiving the signals originating from code discriminators are not coupled to a (mean, offset) converter after weighting,
two carrier loop filters each coupled to one of first two weighted inputs if the first two inputs receiving the signals originating from phase discriminators are not coupled to a (mean, offset) converter after weighting.

16. The loop corrector as claimed in claim 13, comprising:
two code loop filters each coupled to one of two following weighted inputs if the two following inputs receiving the signals originating from code discriminators are not coupled to a (mean, offset) converter after weighting,
two carrier loop filters each coupled to one of first two weighted inputs if the first two inputs receiving the signals originating from phase discriminators are not coupled to a (mean, offset) converter after weighting.

17. The dual-frequency reception method as claimed in claim 1 wherein:
the relative speed is equal to the output from the offsets loop correcting step weighted by
$$\frac{1}{{λ}_{1}^{2} - {λ}_{2}^{2}} ,$$
the carrier speed (respectively code speed) is equal to
$$\frac{1}{α + β} {v}_{m} - \frac{β}{α + β} {v}_{e}$$
for the frequency associated with α and
$$\frac{1}{α + β} {v}_{m} - \frac{α}{α + β} {v}_{e}$$
for the frequency associated with β if the discriminator is a phase discriminator.

18. The (mean, offset) converter as claimed in claim 2 wherein:
the relative speed is equal to the output from the offsets loop corrector weighted by
$$\frac{1}{{λ}_{1}^{2} - {λ}_{2}^{2}} ,$$
the carrier speed (respectively code speed) is equal to
$$\frac{1}{α + β} {v}_{m} - \frac{β}{α + β} {v}_{e}$$
for the frequency associated with α and
$$\frac{1}{α + β} {v}_{m} - \frac{α}{α + β} {v}_{e}$$
for the frequency associated with β if the discriminator is a phase discriminator.

19. The dual-frequency receiver as claimed in claim 13 wherein:
the relative speed is equal to the output from the offsets loop corrector weighted by
$$\frac{1}{{λ}_{1}^{2} - {λ}_{2}^{2}} ,$$
the carrier speed (respectively code speed) is equal to
$$\frac{1}{α + β} {v}_{m} - \frac{β}{α + β} {v}_{e}$$
for the frequency associated with α and
$$\frac{1}{α + β} {v}_{m} - \frac{α}{α + β} {v}_{e}$$
for the frequency associated with β if the discriminator is a phase discriminator.
